(19) United States
(12) Patent Application Publication
(10) Pub. No.: US 2018/0045602 A1
(43) Pub. Date: Feb. 15, 2018

(54) OPTICAL ELEMENT TESTING METHODS AND SYSTEMS EMPLOYING A BROADBAND ANGLE-SELECTIVE FILTER

(71) Applicant: Halliburton Energy Services, Inc., Houston, TX (US)

(72) Inventors: David L. Perkins, The Woodlands, TX (US); James M. Price, Spring, TX (US)

(21) Appl. No.: 15/556,385

(22) PCT Filed: Aug. 12, 2015
(86) PCT No.: PCT/US2015/044908

§ 371 Date: Sep. 7, 2017

Related U.S. Application Data
(63) Continuation of application No. PCT/US2015/025866, filed on Apr. 15, 2015.
Application No. PCT/US2015/025866 is a continuation of application No. PCT/US2015/025922, filed on Apr. 15, 2015.
Application No. PCT/US2015/025922 is a continuation of application No. PCT/US2015/025869, filed on Apr. 15, 2015.

(51) Int. Cl. G01M 11/00; G01N 21/55; G01N 21/21; G01N 21/25

(52) U.S. Cl. CPC G01M 11/00; G01N 21/25; G01N 21/55; G01N 21/211; E21B 49/088

(57) ABSTRACT

An optical element testing system includes a broadband angle-selective filter arranged along an optical path with an optical element to be tested. The system also includes a electromagnetic radiation transducer that outputs a signal in response to electromagnetic radiation that passes through the broadband angle-selective filter. The system also includes a storage device that stores data corresponding to the signal output from the electromagnetic radiation transducer, wherein the data indicates a property of the optical element in response to a test.

### BACKGROUND

Various tools exist to analyze samples using electromagnetic radiation. One example sample analysis tool, referred to as a photometer, provides information regarding how the properties of electromagnetic radiation are affected due to being reflected off of, emitted from, or passed through a sample. Another example tool, referred to as a ellipsometer, provides information regarding how the polarization of electromagnetic radiation is affected due to being reflected off of or passed through a sample. Another example tool, referred to as a spectrometer, provides information regarding how particular wavelengths of electromagnetic radiation are affected due to being reflecting off of, emitted from, or passed through a sample. Previous efforts to improve the performance of sample analysis tools include careful arrangement of one or more optical elements along an optical path. The performance of an optical element used in a sample analysis tool is a function of the optical element fabrication process. In an example optical element fabrication process, one or more layers are deposited on a substrate in an effort to provide a desired filtration result (e.g., light intensity filtration, light wavelength filtration, light polarization filtration). Due to variations in the fabrication process, it is difficult to mass produce optical elements with the same operational characteristics.

One way to improve the optical element fabrication process is to test operational characteristics of optical elements during the fabrication process. Such testing is not a trivial process and is negatively affected by the fabrication environment. For example, heat and vibration sources in the fabrication environment can introduce scattered electromagnetic radiation that increases the amount of error when testing the operational characteristics of an optical element.

### BRIEF DESCRIPTION OF THE DRAWINGS

Accordingly, there are disclosed herein optical element testing methods and systems employing a broadband angle-selective filter. In the drawings:

FIGS. 1A-1C shows block diagrams of illustrative optical element testing system configurations;

FIG. 2 shows a block diagram of an illustrative sample analysis tool;

FIG. 3A shows an illustrative drilling environment;

FIG. 3B shows an illustrative wireline logging environment; and

FIG. 4 shows an illustrative optical element testing method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

Disclosed herein are optical element testing systems and methods employing a broadband angle-selective filter. In different embodiments, the testing systems and methods may be employed during and/or after fabrication of an optical element. As used herein, the term “broadband angle-selective filter” refers to an optical component that allows electromagnetic radiation at a wide range of frequencies to pass though it, but only at a particular incident angle or narrow range of incident angles. Without limitation, a documented broadband angle-selective filter is 98% transparent to p-polarized incident electromagnetic radiation at an angle of 55°+/− about 4°. See Yichen Shen et al., Optical Broadband Angular Selectivity, Science 343, 1499 (2014). The use of a broadband angle-selective filter in optical element testing systems and methods provides options that could enhance or replace existing testing designs. In different embodiments, optical elements obtained using the disclosed testing systems and methods can be employed in a variety of optical tools such as sample analysis tools (e.g., photometers, ellipsometers, and spectrometers).

As used herein, an “optical element” refers to an optical component that reflects, absorbs, or otherwise affects incident electromagnetic radiation passing through it, emitted from it, or reflecting from it as a function of wavelength, polarity, and/or incident angle.

Examples of optical elements include one or more of an optical filter, a polarizing element, a wavelength selection element, and an integrated computation element (ICE). In some cases, optical elements subject to the disclosed testing methods and systems correspond to stand-alone components that can be deployed along an optical path of sample analysis tool or other optical tool. In other cases, optical elements subject to the disclosed testing methods and systems correspond to combination components, where an optical element is combined with another component that can be deployed along an optical path of sample analysis tool or other optical tool. Example combination components include an electromagnetic radiation source, a lens, or an electromagnetic radiation transducer (a detector) with one or more optical element layers applied to at least one of its surfaces.

In at least some embodiments, an example optical element testing system includes a broadband angle-selective filter arranged along an optical path with an optical element to be tested. The system also includes an eletromagnetic radiation transducer that outputs a signal in response to electromagnetic radiation that passes through the broadband angle-selective filter. The system also includes a storage device that stores data corresponding to the signal output from the eletromagnetic radiation transducer, wherein the data indicates a property of the optical element in response to a test. Meanwhile, an example optical element testing method includes arranging an optical element to be tested and a broadband angle-selective filter along an optical path. The method also includes outputting a signal in response to electromagnetic radiation that passes through the broadband angle-selective filter. The method also includes storing data corresponding to the signal, wherein the data indicates a property of the optical element in response to a test. Various optical element testing options, optical element fabrication options, and sample analysis tool options that may be benefit from optical elements obtained using the disclosed testing and fabrication options are described herein.

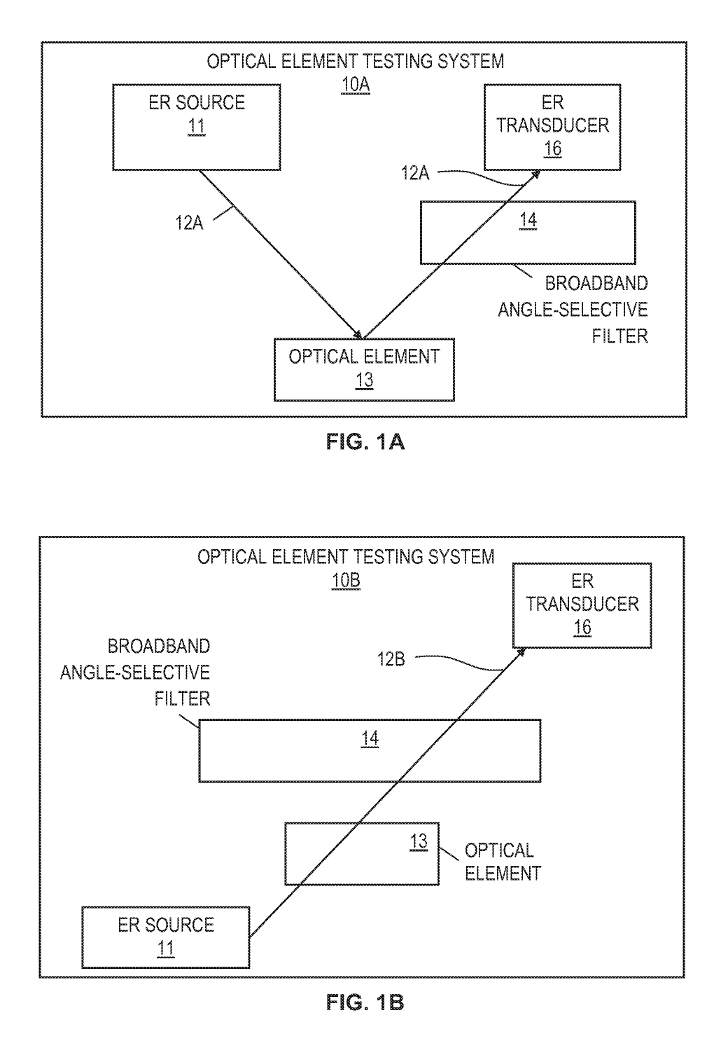

The disclosed systems and methods are best understood when described in an illustrative usage context. FIGS. 1A-1C show block diagrams of different optical element testing system configurations 10A-10C. In the configuration 10A of FIG. 1A, the electromagnetic radiation to be analyzed corresponds to the optical path 12A, where electromagnetic radiation emitted from the electromagnetic radiation (ER) source 11 reflects off a surface of optical element 13, passes through broadband angle-selective filter 14, and arrives to ER transducer 16. The signal output by the ER transducer 16 in response to incident electromagnetic radiation is digitized, stored, and analyzed to characterize a property of the optical element 13 in response to a test (e.g., an optical monitor test, an ellipsometry test, or a spectrometry test). For example, the configuration of FIG. 1A, can be used to identify optical monitor characteristics of the optical element 13 (e.g., how intensity of electromagnetic radiation emitted from ER source 11 and corresponding to a discrete wavelength or range is affected due to being reflected off of the optical element 13), ellipsometry characteristics of the optical element 13 (i.e., how the polarization of electromagnetic radiation emitted from ER source 11 is affected due to being reflected off of the optical element 13), or spectrometry characteristics of the optical element 13 (i.e., how particular wavelengths of electromagnetic radiation emitted from ER source 11 are affected due to being reflected off of the optical element 13).

In the configuration 10B of FIG. 1B, the electromagnetic radiation to be analyzed corresponds to the optical path 12B, where electromagnetic radiation emitted from the ER source 11 passes through optical element 13, passes through broadband angle-selective filter 14, and arrives to ER transducer 16. The signal output by the ER transducer 16 in response to incident electromagnetic radiation is digitized, stored, and analyzed to characterize a property of the optical element 13 in response to a test (e.g., an optical monitor test, an ellipsometry test, or a spectrometry test). For example, the configuration of FIG. 1B, can be used identify optical monitor characteristics of the optical element 13 (e.g., how intensity of electromagnetic radiation emitted from ER source 11 and corresponding to a discrete wavelength or range is affected due to passing through the optical element 13), ellipsometry characteristics of the optical element 13 (i.e., how the polarization of electromagnetic radiation emitted from the ER source 11 is affected due to passing through the optical element 13), or spectrometry characteristics of the optical element 13 (i.e., how particular wavelengths of electromagnetic radiation emitted from the ER source 11 are affected due to passing through the optical element 13). In different embodiments, optical element testing system configurations such as configuration 10A and 10B can be combined with optical element fabrication or modification equipment to expedite obtaining an optical element with desired characteristics.

In the optical element testing system configuration 10C of FIG. 1C, a testing section 20 and a fabrication section 30 are represented. Note: components of the testing section 20 may be positioned on different sides of the fabrication section 30 using suitable ports or windows 37A-37D. Additionally or alternatively, components of the testing section 20 may be included within fabrication section 20 (e.g., within deposition chamber 31). Further, a computer system 70 is represented, where the computer system 70 may direct the operations of and/or receive measurements from components of the testing section 20 and/or the fabrication section 30. The computer system 70 may also display related information and/or control options to an operator. The interaction of the computer system 70 with the testing section 20 and/or the fabrication section 20 may be automated and/or subject to user-input.

In at least some embodiments, the computer system 70 includes a processing unit 72 that displays test options, fabrication options, and/or test results by executing software or instructions obtained from a local or remote non-transitory computer-readable medium 78. The computer system 70 also may include input device(s) 76 (e.g., a keyboard, mouse, touchpad, etc.) and output device(s) 74 (e.g., a monitor, printer, etc.). Such input device(s) 76 and/or output device(s) 74 provide a user interface that enables an operator to interact with components of the testing section 20, components of the fabrication section 30, and/or software executed by the processing unit 72. For example, the computer system 70 may enable an operator to select test options (e.g., ellipsometer test, spectrometer test, optical monitor test, or adjustable parameters), to view test results, to select fabrication options, and/or to perform other tasks. As previously mentioned, at least some tasks performed by the computer system 70 (e.g., to direct components of the testing section 20, to direct components of the fabrication section 30, to store test results, to display test results, etc.) may be automated. In at least some embodiments, the operations of the fabrication section 30 are based, at least in part, on measurements collected by the testing section 20. While the discussion for configuration 10C focuses on testing and fabrication of ICE components 33, it should be appreciated that other types of optical elements 13 could similarly be tested during fabrication or modification.

In accordance with at least some embodiments, the fabrication section 30 includes a deposition chamber 31 with one or more deposition sources 38 to provide materials with low complex index of refraction n*L and high complex index of refraction n*H used to form layers of ICEs 33. Substrates on which layers of the ICEs 33 will be deposited are placed on a substrate support 32. The substrates have a thickness and a complex refraction index specified by the ICE design. In different embodiments, various deposition techniques can be used to form a stack of layers for each of the ICEs 33 in accordance with a target ICE design. Example deposition techniques include physical vapor deposition (PVD), chemical vapor deposition (CVD), atomic layer deposition (AVD), and molecular beam epitaxy (MBE). During PVD operations, for example, the layers of the ICEs 33 are formed by condensation of a vaporized form of material(s) of the deposition source(s) 38, while maintaining a deposition chamber vacuum. In some embodiments, PVD is performed using electron beam (E-beam) deposition, in which a beam of high energy electrons is electromagnetically focused onto material(s) of the deposition source(s) 38 to evaporate atomic species (e.g., Si or SiO₂). In some cases, E-beam deposition is assisted by ions that clean or etch the ICE substrate(s) and/or increase the energies of the evaporated material(s), such that they are deposited onto the substrates more densely. If ions are used, an ion source could be added to the fabrication section 30.

Another PVD technique that can be used to form the stack of layers of each of the ICEs 33 is cathodic arc deposition, in which an electric arc discharged at the material(s) of the deposition source(s) 38 blasts some of the material(s) into ionized vapor to be deposited onto the ICEs 33 being formed. Yet another PVD technique that can be used to form the stack of layers of each of the ICEs 33 is evaporative deposition, in which material(s) included in the deposition source(s) 38 is heated to a high vapor pressure by electrically resistive heating. Yet another PVD technique that can be used to form the stack of layers of each of the ICEs s 33 is pulsed laser deposition, in which a laser ablates material(s) from the deposition source(s) 38 into a vapor. Yet another PVD technique that can be used to form the stack of layers of each of the ICEs 33 is sputter deposition, in which a glow plasma discharge (usually localized around the deposition source(s) 38 by a magnet bombards the material(s) of the source(s) 38 sputtering some away as a vapor for subsequent deposition.

In different embodiments, the relative orientation of and separation between the deposition source(s) 38 and the substrate support 32 may vary to provide a desired deposition rate(s) and spatial uniformity across the ICEs 33 disposed on the substrate support 32. In the event the spatial distribution of a deposition plum provided by the deposition source(s) 38 is non-uniform, the support assembly 34 may periodically move the substrate support 32 relative to the deposition source(s) 38 along at least one direction. For example, the support assembly 34 may support a transverse motion (e.g., up, down, left, right along a straight line such as the “r” or “z” axes represented) of the substrate support 32 in a deposition chamber and/or a rotational motion around an axis 36 (e.g., a change in azimuthal direction “0”) to obtain reproducibly uniform layer depositions for the ICEs 33 within a batch.

The testing section 20 used with the fabrication section 100 may include multiple components. As represented in FIG. 1C, the position of components for the testing section 20 may vary to enable reflection-based analysis or pass-through (i.e. transmission) analysis of optical layers being fabricated. While not specifically shown, in at least some embodiments, the testing section 20 may include a physical thickness monitor such as a quartz crystal microbalance (not shown) to measure a deposition rate. The measured deposition rate may be used to direct operations of the deposition source(s) 38 (i.e., the deposition rate may be increased or decreased) and/or the operations of the substrate support 32 (e.g., to move the substrate support 32 relative to the deposition source(s) 38). In some embodiments, complex refractive indices and layer thickness may be determined by the computer system 70 using measurements of how electromagnetic radiation emitted from an EM source (e.g., ER source 22A or 22B) interacted with the formed layers of a particular test ICE 33_{T} (the ICE 33 being tested). The electromagnetic radiation emitted from ER source 22A or 22B corresponds to any type of electromagnetic radiation having one or more probe wavelengths from an appropriate region of the electromagnetic spectrum. The testing section 20 also includes at least one ER transducer (e.g., ER transducer 26A and 26B) configured to receive electromagnetic radiation after is has interacted with test ICE 33T and passed through a respective broadband angle-selective filter 28A or 28B. More specifically, ER transducer 26A is arranged to receive electromagnetic radiation emitted by ER source 22A and reflected from test ICE 33_{T}, while ER transducer 26B is arranged to receive electromagnetic radiation emitted by ER source 22B and passed through test ICE 33T.

In at least some embodiments, the testing section 20 performs an ellipsometry test. For example, the ellipsometry test may involve the ER transducer 26A measuring (e.g., during or after forming the jth layer of the ICEs 33) amplitude and phase components (Ψ, Δ) of elliptically polarized probe-light provided by ER source 22A after reflection from a stack with j layers corresponding to test ICE 33T. The probe-light is provided by the ER source 22A, for example, through a probe port or window 37A in deposition chamber 31. Meanwhile, the reflected electromagnetic radiation arrives to ER transducer 26A through another port or window 37C in deposition chamber 31. The measured amplitude and phase components (Ψ, Δ) can be used by computer system 70 to determine the real and imaginary components of the complex refractive indices and the thicknesses of each of the formed layers in the stack. In at least some embodiments, the computer system 70 makes this determination by solving Maxwell's equations for propagating/reflecting probe-light corresponding to the ellipsometry test through the formed layers of test ICE 33_{T}.

Additionally or alternatively, the testing section 20 may perform an optical monitor test. For example, the optical monitor test may involve measuring (e.g., during or after forming the jth layer of the ICEs 33) change of intensity of a probe-light provided by ER source 22B and passed through a stack with j layers corresponding to test ICE 33_{T}. For the optical monitor test, the probe-light has one or more “discrete” wavelengths {λk, k=1, 2, . . . }, where a discrete wavelength λk includes a center wavelength λk within a narrow bandwidth Δλk (e.g., ±5 nm or less) and where two or more wavelengths, λ1 and λ2, contained in the probe-light have respective bandwidths Δλ1 and Δλ2 that are not overlapping. The ER source 22B may be, for example, a continuous wave (CW) laser. As represented in FIG. 1C, the ER source 22B provides probe-light through a port or window 37B in deposition chamber 31. Meanwhile, the ER transducer 26B collects corresponding measurements through another port or window 37D. The measured change of intensity I(j;λk) can be used by the computer system 70 to determine the complex refractive indices and thicknesses of each of the formed layers in the stack. In at least some embodiments, the computer system 70 makes this determination by solving Maxwell's equations for propagating probe-light corresponding to the optical monitor test through the formed layers of test ICE 33_{T}.

Additionally or alternatively, the testing section 20 may perform a spectrometry test. For example, the spectrometry test may involve measuring (e.g., during or after forming the s jth layer of the ICEs 33) a spectrum S(j;λ) of electromagnetic radiation provided by a ER source 22B and passed through a stack with j layers corresponding to test ICE 33_{T}, where the electromagnetic radiation may have a broad and continuous wavelength range from λmin to λmax. Note: in order to perform the optical monitor test and the spectrometry test, the ER source 22B could correspond to broadband electromagnetic radiation source components and narrowband electromagnetic radiation source components needed for both types of tests. For the spectrometry, the ER source 22B provides the broadband electromagnetic radiation through a port or window 37B in deposition chamber 31. Meanwhile, the ER transducer 26B collects corresponding measurements through another port or window 37D. The spectrum S(j;λ) measured by the ER transducer 26B (over the wavelength range from λmin to λmax), can be used by the computer system 70 to determine the complex refractive indices and thicknesses of each of the formed layers in the stack. In at least some embodiments, the computer system 70 makes this determination by solving Maxwell's equations for propagating probe-light corresponding to the spectrometry test through the formed layers of test ICE 33_{T}.

In at least some embodiments, a test ICE 33_{T} is at rest with respect to components of the testing section 20 when test measurements are being collected. In such case, deposition of a layer L(j) is interrupted or completed prior to performing the measurement. For some of the layers of an ICE design, the testing section 20 may measure the characteristics of probe-light that has interacted with test ICE 33_{T} after the layer L(j) has been deposited to its full target thickness t(j), or equivalently, when deposition of the layer L(j) is completed. Alternatively, the testing section 20, may measure the characteristics of probe-light that has interacted with test ICE 33_{T} during the deposition of the layer L(j). In different scenarios, such a measurement can be taken when the layer L(j) has been deposited to a fraction of its target thickness (e.g., f=50%, 80%, 90%, 95%, etc.). In other embodiments, test ICE 33_{T} moves with respect to components of the testing section 20. For example, support assembly 34 may cause the substrate support 32 and ICEs 33 to move (e.g., up, down, left, right, rotate) when test measurements are being collected. In such case, deposition of the layer L(j) may, but need not be, interrupted or completed prior to performing test measurements. For at least some of the layers of the ICE design, test measurements are collected continuously for the entire duration ΔT(j) of the deposition of the layer L(j), or for portions of the deposition process (e.g., during the last 50%, 20%, 10% of the process). Again, the test measurements may correspond to an ellipsometry test, an optical monitor test, or a spectrometry test as described herein. As desired, collected measurements can be averaged over a number of time or movement intervals (e.g., 5 intervals). As another example, multiple ICEs 33 (not just test ICE 33_{T}) can be successively tested as support assembly moves each ICE 33 relative to components of the testing section 20. The test measurements obtained for different ICEs 33 can be averaged.

One complication with obtaining test measurements of near-infrared (NIR) or mid-infrared (MIR) transmission spectra is that stray electromagnetic radiation emanating from any warm (e.g., a blackbody) surface inside the deposition chamber 31 can arrive to ER transducers 26A and 26B and interfere with test measurements. Another complication can occur when stray electromagnetic radiation from one of ER sources 22A or 22B (i.e., electromagnetic radiation that has not interacted with test ICE 33_{T}) arrives to ER transducer 26A or 26B. The stray electromagnetic radiation may be due to components in the deposition chamber 31 and/or vibrations in the deposition chamber 31. To avoid such interference with the test measurements, the broadband angle-selective filters 28A and 28B are positioned before their respective ER transducer 26A and 26B. In this manner, unwanted stray electromagnetic radiation from undesirable angles is blocked by the broadband angle-selective filters 28A and 28B, improving the obtained test measurements.

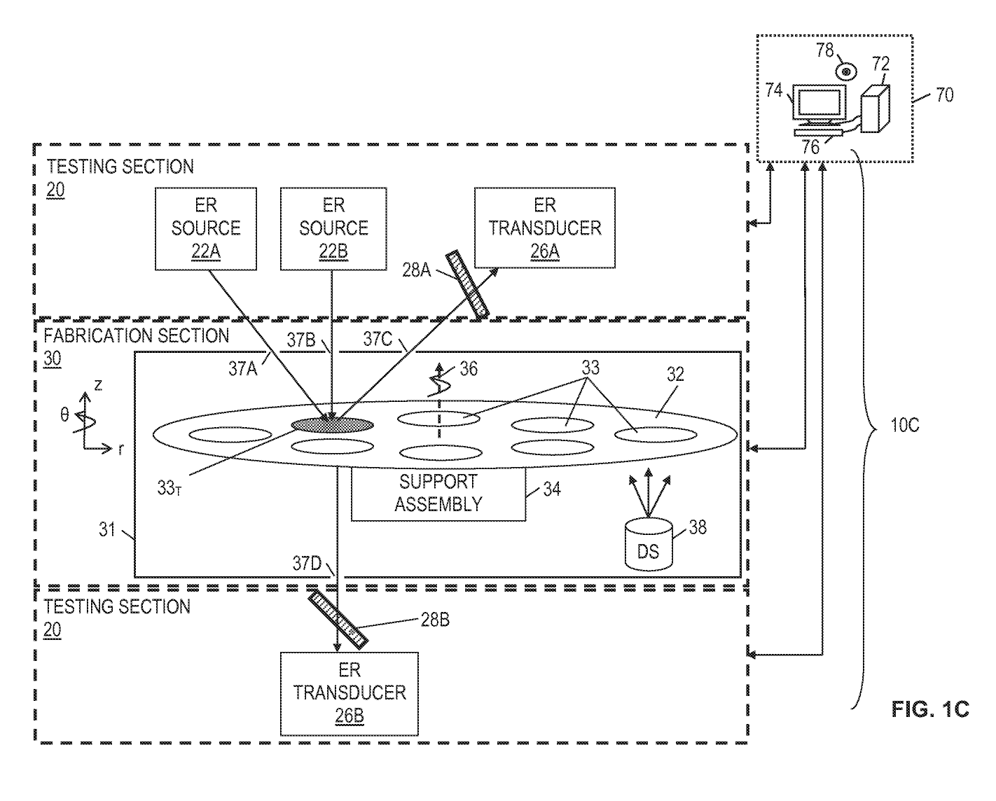

ICEs 33 and/or other optical elements 13 that have been fabricated and/or modified based on test results as described herein may be employed in different tools such as a sample analysis tool. FIG. 2 shows an illustrative sample analysis tool 40. The sample analysis tool 40 includes a ER source 41, sample chamber 42, at least one optical element 13, and at least one ER transducer 46 arranged along an optical path 50. The arrangement and orientation of the components deployed along the optical path 50 may vary. Further, the optical path 10 does not necessarily correspond to a straight path (e.g., there may be corners, curves, or other directional changes along the optical path 50). Further, the sample analysis tool 40 may include spatial masking components, imaging optics, and/or lenses along the optical path 50. Alternatively, such components can be omitted depending on the arrangement of the the ER transducer(s) 46.

In some embodiments, the ER source 41 can be omitted if electromagnetic radiation external to the sample analysis tool 40 is available. Further, in some embodiments, a sample 43 within sample chamber 42 is capable of emitting electromagnetic radiation (e.g., through a transparent window of the sample chamber 42) and can serve as the ER source 41. In different embodiments, the optical element(s) 13 enable the sample analysis tool 40 to obtain photometry measurements, ellipsometry measurements, or spectrometry measurements that can be used to characterize or identify the sample 43.

In at least some embodiments, the sample analysis tool 40 also includes at least one digitizer 47 to convert analog signals from each ER transducer 46 to a corresponding digital signal. Further, the sample analysis tool 40 may include data storage 48 to store data corresponding to the output of each ER transducer 46. As another option, the sample analysis tool 40 may include a communication interface 49 to convey data corresponding to the output of each ER transducer 46 to another device. Additionally or alternatively, the sample analysis tool 40 may include a processing unit (not shown) to process data and/or a display unit (not shown) to display data corresponding to the output of each ER transducer 46. For example, the data corresponding to the output of each ER transducer 46 may be analyzed to identify a property of the sample 43. As an example, the identified property may correspond to a density (or other physical parameter) and/or a chemical component. The identified property may be displayed via a display unit and/or may be transmitted using the communication interface 49 to another device. The configuration of the sample analysis tool 40 may vary depending on the environment in which the sample analysis tool 40 is used. For example, a downhole configuration for the sample analysis tool 40 may differ from a laboratory configuration for the sample analysis tool 40 due to spatial constraints, sampling constraints, power constraints, ambient parameters (temperature, pressure, etc.), or other factors.

Further, it should be appreciated that the sample analysis tool 40 may include components for obtaining a sample. For example, to sample fluid in a downhole environment, the sample analysis tool 40 may include a sampling interface that extends to a borehole wall and draws fluid from a formation. Further, the sampling interface may direct the formation fluid to the sample chamber 42. As desired, obtained samples can be stored for later analysis once a sample analysis tool 40 is retrieved (e.g., from a downhole environment) or the samples can be flushed to allow for analysis of a subsequent sample while the sample analysis tool 40 remains in a downhole environment. Further, it should be appreciated that the sample analysis tool 40 may include components for controlling the pressure or temperature of a sample during analysis.

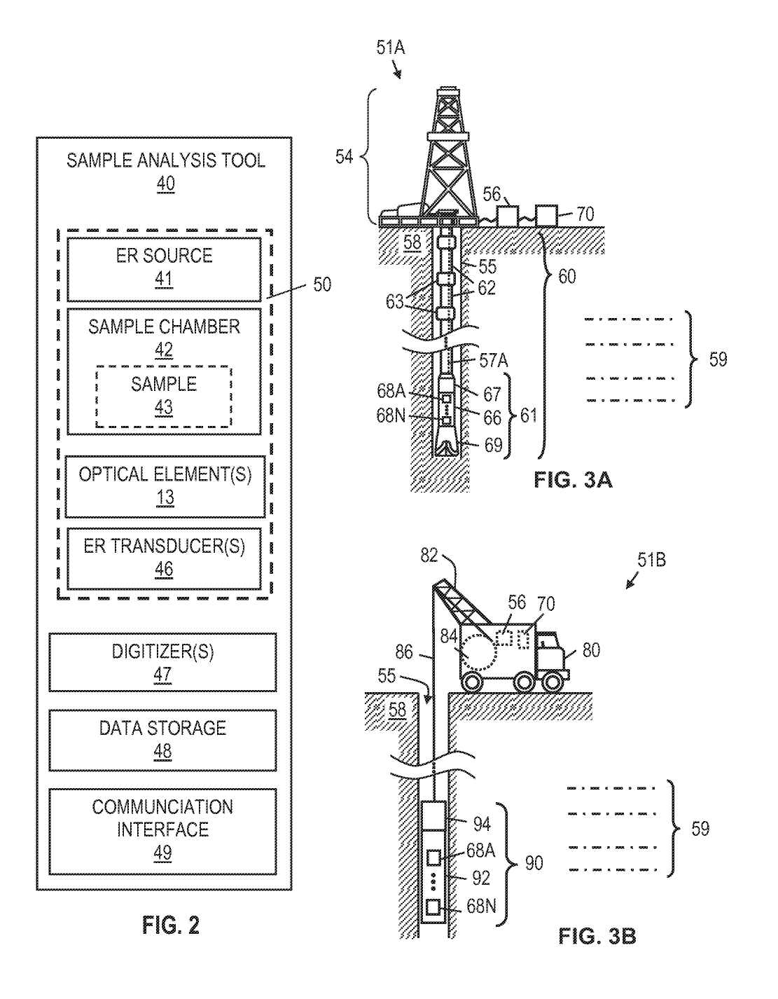

FIG. 3A shows an illustrative drilling environment 51A. In FIG. 3A, a drilling assembly 54 enables a drill string 60 to be lowered and raised in a borehole 55 that penetrates formations 59 of the earth 58. The drill string 60 is formed, for example, from a modular set of drill string segments 62 and adaptors 63. At the lower end of the drill string 60, a bottomhole assembly 61 with a drill bit 69 removes material from the formations 59 using known drilling techniques. The bottomhole assembly 61 also includes one or more drill collars 67 and a downhole tool 66 with one or more sample analysis units 68A-68N, each of which may correspond to some variation of the sample analysis tool 40 described for FIG. 2. To collect fluid samples in the drilling environment 51A, a sampling interface (not shown) is included with the downhole tool 66. For example, the sampling interface may be integrated with a drill collar 67 close to drill bit 69. As needed, the drilling operations can be halted to allow fluid samples to be obtained using known sampling techniques.

In addition to the sample analysis units 68A-68N, the downhole tool 66 may also include electronics for data storage, communication, etc. In different embodiments, sample analysis measurements obtained by the one or more sample analysis units 68A-68N are conveyed to earth's surface using known telemetry techniques (e.g., wired pipe telemetry, mud pulse telemetry, acoustic telemetry, electromagnetic) and/or are stored by the downhole tool 66. In at least some embodiments, a cable 57A may extend from the BHA 61 to earth's surface. For example, the cable 57A may take different forms such as embedded electrical conductors and/or optical waveguides (e.g., fibers) to enable transfer of power and/or communications between the bottomhole assembly 61 and earth's surface. In other words, the cable 57A may be integrated with, attached to, or inside the modular components of the drill string 60.

In FIG. 3A, an interface 56 at earth's surface receives sample analysis measurements (or other data collected downhole) via cable 57A or another telemetry channel and conveys the sample analysis measurements to a computer system 50. In some embodiments, the surface interface 26 and/or the computer system 50 may perform various operations such as converting signals from one format to another, storing sample analysis measurements and/or processing sample analysis measurements to recover information about properties of a sample. As an example, in at least some embodiments, the computer system 50 includes a processing unit 52 that displays sample analysis measurements or related sample properties by executing software or instructions obtained from a local or remote non-transitory computer-readable medium 58. The computer system 50 also may include input device(s) 56 (e.g., a keyboard, mouse, touchpad, etc.) and output device(s) 54 (e.g., a monitor, printer, etc.). Such input device(s) 56 and/or output device(s) 54 provide a user interface that enables an operator to interact with the downhole tool 66 and/or software executed by the processing unit 52. For example, the computer system 70 may enable an operator to select sampling options, to select sample analysis options, to view collected sample analysis measurements, to view sample properties obtained from the sample analysis measurements, and/or to perform other tasks. Further, information about the downhole position at which a particular sample is collected may be taken into account and used to facilitate well completion decisions and/or other strategic decisions related to producing hydrocarbons.

At various times during the drilling process, the drill string 61 shown in FIG. 3A may be removed from the borehole 55. With the drill string 60 removed, another option for performing sample analysis operations involves the wireline environment 51B of FIG. 3B. In FIG. 3B, a wireline tool string 90 is suspended in a borehole 55 that penetrates formations 59 of the earth 58. For example, the wireline tool string 90 may be suspended by a cable 86 having conductors and/or optical fibers for conveying power to the wireline tool string 90. The cable 86 may also be used as a communication interface for uphole and/or downhole communications. In at least some embodiments, the cable 86 wraps and unwraps as needed around cable reel 84 when lowering or raising the wireline tool string 90. As shown, the cable reel 84 may be part of a movable logging facility or vehicle 80 having a cable guide 82.

In at least some embodiments, the wireline tool string 90 includes logging tool(s) 94 and a downhole tool 92 with one or more sample analysis units 68A-68N, each of which may correspond to some variation of the sample analysis tool 40 described for FIG. 2. The downhole tool 62 may also include electronics for data storage, communication, etc. The sample analysis measurements obtained by the one or more sample analysis units 38A-38N are conveyed to earth's surface and/or are stored by the downhole tool 62. In either case, the sample analysis measurements can be used to determine one or more properties of a sample collected in the downhole environment. For example, the sample analysis measurements may be used to determine a sample density, to identify presence or absence of a chemical, and/or to determine another property of a sample. Further, information about the downhole position at which a particular sample was collected may be taken into account and used to facilitate well completion decisions and/or other strategic decisions related to producing hydrocarbons.

At earth's surface, a surface interface 56 receives the sample analysis measurements via the cable 86 and conveys the sample analysis measurements to a computer system 70. As previously discussed, the interface 56 and/or computer system 70 (e.g., part of the movable logging facility or vehicle 80) may perform various operations such as converting signals from one format to another, storing the sample analysis measurements, processing the sample analysis measurements, displaying the sample analysis measurements or related sample properties, etc.

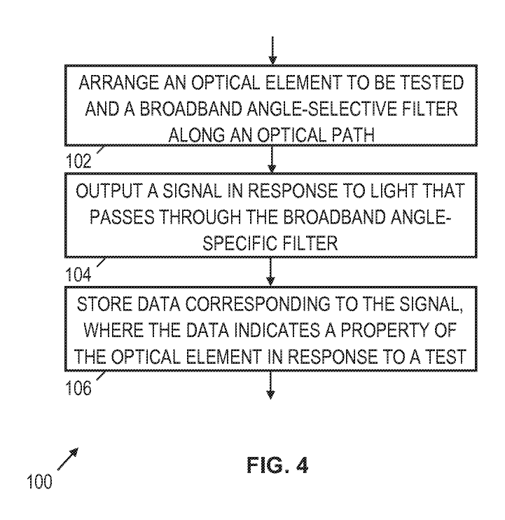

FIG. 4 shows an illustrative optical element testing method 100. As shown, method 100 comprises arranging an optical element to be tested and a broadband angle-selective filter along an optical path (block 102). At block 104, a signal is output in response to electromagnetic radiation that passes through the broadband angle-selective filter. The electromagnetic radiation may correspond to an ellipsometry test, an optical monitor test, or a spectrometry test as described herein. At block 106, data corresponding to the signal is stored, where the data indicates a property of the optical element in response to a test. In accordance with at least some embodiments, the optical element testing method 100 may be performed during fabrication of an optical element to guide fabrication processes such as PVD. Alternatively, the optical element testing method 100 may be performed after fabrication is complete to test functionality of a fabricated optical element. In either case, modification of an optical element or a batch of optical elements may be based on the test results. After fabrication or modification, optical elements that have undergone the testing process described herein can be employed with tools such as sample analysis tools as described herein.

### Embodiments Disclosed Herein Include:

A: An optical element testing system comprises a broadband angle-selective filter arranged along an optical path with an optical element to be tested. The system also comprises a ER transducer that outputs a signal in response to electromagnetic radiation that passes through the broadband angle-selective filter. The system also comprises a storage device that stores data corresponding to the signal output from the ER transducer, wherein the data indicates a property of the optical element in response to a test.

B: An optical element testing method comprises arranging an optical element to be tested and a broadband angle-selective filter along an optical path. The method also includes outputting a signal in response to electromagnetic radiation that passes through the broadband angle-selective filter. The method also includes storing data corresponding to the signal, wherein the data indicates a property of the optical element in response to a test.

Each of the embodiments, A and B, may have one or more of the following additional elements in any combination. Element 1: further comprising a housing and an EM source within the housing. Element 2: further comprising a deposition source and a controller, wherein the controller directs the deposition source to adjust a layer of the optical element or to add a layer to the optical element based on the data. Element 3: further comprising a deposition chamber and a support assembly within the deposition chamber, wherein the controller directs the support assembly to move the optical element transversely within the deposition chamber based on the data. Element 4: further comprising a deposition chamber and a support assembly within the deposition chamber, wherein the controller directs the support assembly to rotate the optical element within the deposition chamber based on the data. Element 5: wherein the controller directs the deposition source to adjust a deposition rate based on the data. Element 6: wherein the broadband angle-selective filter and the ER transducer are arranged to prevent scattered electromagnetic radiation or non-specular electromagnetic radiation from arriving to the ER transducer. Element 7: wherein the data is indicative of an optical monitor test. Element 8: wherein the data is indicative of an ellipsometry test. Element 9: wherein the data is indicative of a spectrometry test. Element 10: wherein the optical element is an ICE.

Element 11: further comprising adjusting a layer of the optical element or adding at least one layer to the optical element based on the data. Element 12: further comprising moving the optical element within a deposition chamber based on the data. Element 13: further comprising adjusting a deposition rate based on the data. Element 14: further comprising using the data to fabricate a batch of optical elements. Element 15: wherein the data is indicative of an optical monitor test. Element 16: wherein the data is indicative of an ellipsometry test. Element 17: wherein the data is indicative of a spectrometry test. Element 18: wherein the optical element is an ICE.

Numerous other variations and modifications will become apparent to those skilled in the art once the above disclosure is fully appreciated. It is intended that the following claims be interpreted to embrace all such variations and modifications where applicable.

1. An optical element testing system, comprising:
a broadband angle-selective filter arranged along an optical path with an optical element to be tested;
a electromagnetic radiation transducer that outputs a signal in response to electromagnetic radiation that passes through the broadband angle-selective filter; and
a storage device that stores data corresponding to the signal output from the electromagnetic radiation transducer, wherein the data indicates a property of the optical element in response to a test.

2. The system of claim 1, further comprising a housing and a electromagnetic radiation source within the housing.

3. The system of claim 1, further comprising a deposition source and a controller, wherein the controller directs the deposition source to adjust a layer of the optical element or to add a layer to the optical element based on the data.

4. The system of claim 3, further comprising a deposition chamber and a support assembly within the deposition chamber, wherein the controller directs the support assembly to move the optical element transversely within the deposition chamber based on the data.

5. The system of claim 3, further comprising a deposition chamber and a support assembly within the deposition chamber, wherein the controller directs the support assembly to rotate the optical element within the deposition chamber based on the data.

6. The system of claim 3, wherein the controller directs the deposition source to adjust a deposition rate based on the data.

7. The system of claim 1, wherein the broadband angle-selective filter and the electromagnetic radiation transducer are arranged to prevent scattered electromagnetic radiation or non-specular electromagnetic radiation from arriving to the electromagnetic radiation transducer.

8. The system according to claim 1, wherein the data is indicative of an optical monitor test.

9. The system according to claim 1, wherein the data is indicative of an ellipsometry test.

10. The system according to claim 1, wherein the data is indicative of a spectrometry test.

11. The system according to claim 1, wherein the optical element is an integrated computational element (ICE).

12. An optical element testing method, comprising:
arranging an optical element to be tested and a broadband angle-selective filter along an optical path;
outputting a signal in response to electromagnetic radiation that passes through the broadband angle-selective filter; and
storing data corresponding to the signal, wherein the data indicates a property of the optical element in response to a test.

13. The method of claim 12, further comprising adjusting a layer of the optical element or adding at least one layer to the optical element based on the data.

14. The method of claim 12, further comprising moving the optical element within a deposition chamber based on the data.

15. The method of claim 12, further comprising adjusting a deposition rate based on the data.

16. The method of claim 12, further comprising using the data to fabricate a batch of optical elements.

17. The method according to claim 1, wherein the data is indicative of an optical monitor test.

18. The method according to claim 1, wherein the data is indicative of an ellipsometry test.

19. The method according to claim 1, wherein the data is indicative of a spectrometry test.

20. The method according to claim 1, wherein the optical element is an integrated computational element (ICE).
